(19) United States
(12) Patent Application Publication
(10) Pub. No.: US 2012/0090552 A1
(43) Pub. Date: Apr. 19, 2012

(54) PET AMUSEMENT DEVICE

(76) Inventor: David Haaf, San Rafael, CA (US)

(21) Appl. No.: 12/903,447

(22) Filed: Oct. 13, 2010

(51) Int. Cl. A01K 15/02

(52) U.S. Cl. 119/706

(57) ABSTRACT

A pet amusement device having a base, stem emanating from the base and a corrugated cardboard cylinder having a circular cross section and opening through its center sized to receive the stem. The corrugations of the cardboard cylinder extend to the outer surface of the cylinder to enable a pet to have access to it during use. The present invention is particularly applicable for use as a scratching surface for a domesticated cat.

### TECHNICAL FIELD

The present invention is directed to a pet amusement device and particularly to a device which is ideally suited to facilitate cat scratching. The device is easy to construct and inexpensive to maintain and is thus ideally suited for use by domestic cat owners.

### BACKGROUND OF THE INVENTION

It is quite important fox the health and well being of a pet to not only feed it properly but also to provide stimulating activities. Pets which become bored often times become destructive not only of their surroundings but also of themselves. Animals which are not appropriately stimulated can actually suffer adverse health effects and as a consequence, proper pet stimulation is a significant consideration for virtually all pet owners.

In addition to pet stimulation, generally, pet cats require rather unique amusement devices not shared by other domestic pets. Specifically, cats require, among other things, surfaces up on which they can scratch. If an appropriate cat scratching surface is not provided, cats will use any available surfaces including upholstered furniture, drapes and rugs to satisfy their need to scratch which could cause significant damage.

There have been a variety of cat scratching devices available in the marketplace for quite some time. The most successful of such devices have surfaces which will eventually be worn out requiring replacement. Such surfaces include, for example, carpet, sisal and corrugated cardboard. Cardboard is the least durable of the cat scratching surfaces but cats enjoy cardboard because the corrugations have the appropriate feel to satisfy their natural scratching tendencies. However, because of the relatively soft nature of corrugated cardboard, scratchers composed of such material must be replaced often tending to unduly contribute to the cost of a cat's maintenance.

It is thus an object of the present invention to provide a pet amusement device in the form of a cat scratcher which is capable of satisfying a cat's need to scratch while yet having replaceable scratching segments to reduce the overall cost of the device.

It is yet a further object of the present invention to provide a bundle of inserts capable of replacing worn and abraded cat scratching surfaces while maintaining the relatively high cost structural components of the amusement device.

These and further objects will be more readily apparent when considering the following disclosure and appended claims.

### SUMMARY OF THE INVENTION

A pet amusement device having a base, stem emanating from the base and a corrugated cardboard cylinder having a circular cross section and opening through its center sized to receive the stem. The corrugations of the cardboard cylinder extend to the outer surface of the cylinder to enable a pet to have access to it during use. The present invention is particularly applicable for use as a scratching surface for a domesticated cat.

### BRIEF DESCRIPTION OF THE FIGURES

FIG. 1 is a perspective view of the present invention in its assembled state.

FIG. 2 is an expanded view of the base, stem and cap portions of the present invention.

FIG. 3 is a side view of a corrugated cylinder for use as a replacement pod together with the subparts of FIG. 2.

FIG. 4 is an expanded view showing individual discs as one embodiment to create the replacement pod of FIG. 3.

FIG. 5 is a perspective view of an alternative embodiment of the present invention.

FIG. 6 is a plan view of the bottom side of a base useful in configuring the present invention.

FIG. 7 is a perspective view of the base of FIG. 6 and mating scratching post for use hereon.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

As noted previously, there is a need to provide domesticated cats with scratching surfaces to satisfy their natural tendency to scratch. Without providing suitable amusement devices for this purpose, cats will tend to scratch household furniture, rugs and drapes causing significant damage to such possessions. Cats very much enjoy scratching corrugated cardboard as this provides the appropriate resistance to scratching and feel that ideally satisfies the cat's need to scratch. In addition, unlike rugs and upholstered surfaces, a cat's claw is unlikely to get hung up and thus injured by cardboard as this material has sufficient breakaway “give” to enable the cat to fully engage it while enabling the cat to pull its claw from the cardboard body at will.

Despite the advantages of corrugated cardboard, there is one distinct disadvantage in using it for cat scratching medium which the present invention addresses. Specifically, because of the relatively soft and forgiving nature of cardboard, it tends to degrade rapidly. Thus, cardboard scratchers require frequent replacement. When the entire scratcher is to be replaced, including not only the scratching surface but also its surrounding support structure, cardboard scratchers can be expensive. The present invention addresses this issue by providing a subassembly which is purchased just once while the actual corrugated cardboard scratching material is intended to be replaced as frequently as necessary at a cost far less than that of comparable cat scratching products.

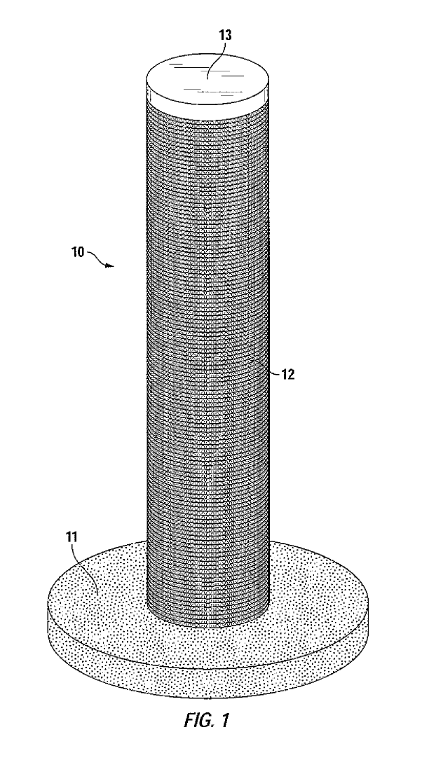

Turning first to FIG. 1, the present invention is shown in its assembled state.

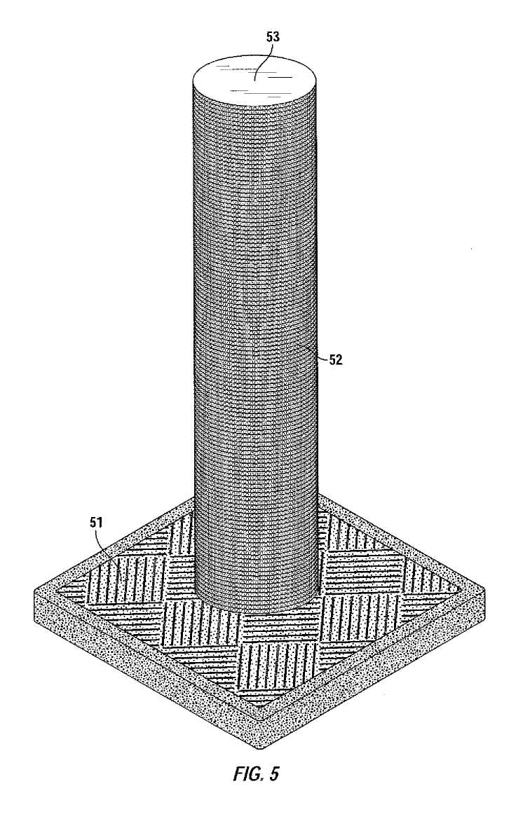

Specifically, base 11, is intended, in use, to reside upon a substantially planar horizontal surface. Base 11 can be itself covered in fabric, carpet or the like which itself can be used as a scratching surface The shape of base 11 is not critical to the present invention. Most importantly, it must be of sufficient dimension to support stem 14 and cylinder 12 in a vertical orientation. As noted, FIG. 1 depicts base 11 as being circular while base 51 of FIGS. 5, 6 and 7 is square or rectangular.

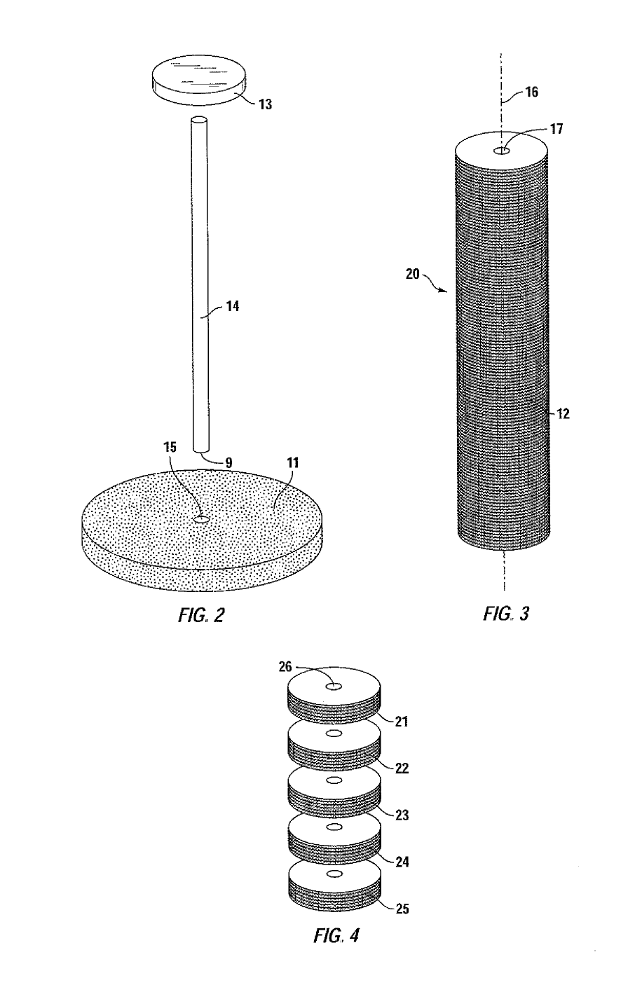

As best shown in FIG. 2, base 11 is provided with centrally located opening 15 for receipt of a mating element 9 of stem 14 for receipt of stem 14 as shown. Element 9 can be screwed or fictionally fit into receiving opening 15 or can pass therethrough with an appropriate fastener releasably securing stem 14 to base 11 on the underside of base 11. As noted, when base 11 is oriented horizontally, stem 14 extends vertically therefrom. Upon the addition of corrugated cardboard cylinder 12 onto stem 14, cap 13 can be releasably applied to the top of stem 14 to maintain corrugated cardboard cylinder 12 thereon.

In turning to FIG. 3, it is quite apparent that corrugated cardboard cylinder 12 has an outer surface as shown and an inner surface defined by centrally located opening 17 which passes through corrugated cardboard cylinder 12 along longitudinal axis 16. In use, cap 13 would be removed from stem 14 and corrugated cardboard cylinder 12 applied to it noting that corrugated cardboard cylinder 12 would reside upon base 11 when in use.

A feature of the present invention is that the corrugations of corrugated cardboard cylinder 12 extend to outer surface 20 and are thus open and fully accessible to a cat during use of the present invention.

It is noted that corrugated cardboard cylinder 12 could be produced from a large corrugated block cut round with a concentric center bore. Alternatively, two half sections could be cut from one or more corrugated blocks and glued together at a seam parallel to longitudinal axis 16. As yet a further embodiment, a series of corrugated discs die cut of double wall construction could be employed and, in this regard, reference is made to FIG. 4.

Turning to FIG. 4, corrugated cardboard discs 21, 22, 23, 24 and 25 are shown individually separated from one another. Each of these discs is provided with centrally located openings 26 which are sized, as was opening 17, to fit upon and thus receive stem 14 along longitudinal axis 16. Individual discs can be loosely stacked upon stem 14 or, alternatively, they can be glued to one another to create what amounts to a unitary corrugated cardboard cylinder as the equivalent of cylinder 12 of FIGS. 1 and 3.

Regardless of the mariner in which corrugated cardboard cylinder 12 is produced, it is quite apparent that the present invention provides a cat owner with an ideal scratcher which can be employed efficiently and at low cost while satisfying the need of a domestic cat to scratch. Specifically, once corrugated cardboard cylinder 12 has been significantly abraded from its use as a scratching surface, cap 13 can be dislodged from stem 14 and corrugated cardboard cylinder 12 or discs 21-25 removed therefrom. A fresh cylinder can then be placed onto stem 14 and cap 13 reapplied. The cat is now provided with a new scratching surface while, at the same time, the pet owner need not replace base 11, stem 14 and cap 13 in the process.

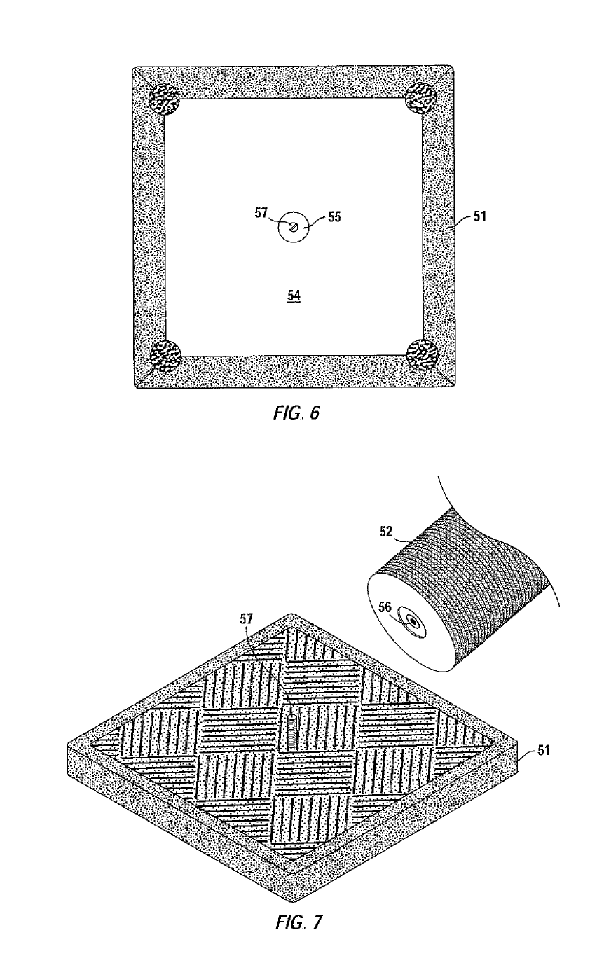

In turning to FIG. 5, cardboard cylinder 52 is shown with top 53 which can be padded or rounded as desired. Cardboard cylinder 52 can be secured to base 51 as shown in FIGS. 6 and 7. Specifically, threaded screw 57 can be secured to bottom 54 within recess 55 so as to not extend beyond surface 54. Cardboard cylinder 52 can be provided with threaded opening 56 to releasably attach base 51 thereto by securing it to threaded screw 57.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A pet amusement device comprising a base, stem emanating from said base and a corrugated cardboard cylinder having a substantially circular cross section and an opening through its center sized to receive said stem.

2. The pet amusement device of claim 1 wherein the corrugations of said cardboard cylinder extend to the outer surface of said cylinder.

3. The pet amusement device of claim 2 wherein said corrugations are accessible to a pet during use of said cylinder.

4. The pet amusement device of claim 1 wherein during use, said base resides upon a substantially horizontal surface and said corrugated cardboard cylinder resides upon said base and maintained in a substantially vertical orientation by said stem.

5. The pet amusement device of claim 4 wherein said stem is further provided with a removable cap for releasably securing said corrugated cardboard cylinder to said stem.

6. A cat scratching replacement pod for use with a pet amusement device, said pet amusement device comprising a base and stem emanating from said base, said cat scratching replacement pod comprising a corrugated cardboard cylinder having an inner and outer surface and a substantially circular cross section and a centrally located longitudinal axis, an opening along said longitudinal axis, said opening sized to receive said stem at said inner surface and corrugations extending to said outer surface.

7. A pet amusement device comprising a base, stem emanating from said base and a plurality of cardboard discs nesting onto said stem which collectively provide a corrugated surface.

8. The device of claim 7 wherein each cardboard disc has a circular cross a circumference defining said corrugated surface and an opening through its circular cross section, said opening sized to receive said stem.

9. The device of claim 7 wherein each cardboard disc comprises a planar top surface and a planar bottom surface, said top and bottom surfaces being substantially circular and being separated by a corrugated body portion.

10. The device of claim 9 wherein said openings are established through said top surface, bottom surface and corrugated body sized for passage of said stem therethrough.

11. The device of claim 7 wherein one of said cardboard discs can be individually removed from said plurality of cardboard discs while maintaining said corrugated surface.

12. A cat scratching replacement pod for use with a pet amusement device, said pet amusement device comprising a base and stem emanating from said base, said cat scratching replacement pod comprising a stack of a plurality of cardboard discs, each disc comprising a planar top surface and planar bottom surface, said top and bottom surfaces being substantially circular and being separated by a corrugated body portion, each of said discs having an opening therethrough sized to receive said stem.
